(19) United States
(12) Patent Application Publication
(10) Pub. No.: US 2026/0250427 A1
(43) Pub. Date: Aug. 27, 2026

(54) METHOD TO REDUCE ALKOXY ETHER RELEASE FROM CELLULOSE ETHERS

(71) Applicant: Dow Global Technologies LLC, Midland, MI (US)

(72) Inventors: Jorg Theuerkauf, Midland, MI (US); Praveenkumar Boopalachandran, Rosharon, TX (US); Scott T. Matteucci, Midland, MI (US); Daniel G. Abebe, Lake Jackson, TX (US); Beata A. Kilos, Midland, MI (US); Kanjakha Pal, Lake Jackson, TX (US); Kefu Sun, Sugar Land, TX (US)

(21) Appl. No.: 18/875,907

(22) PCT Filed: Jun. 29, 2023
(86) PCT No.: PCT/US2023/069319

§ 371 Date: Dec. 17, 2024

Related U.S. Application Data
(60) Provisional application No. 63/356,629, filed on Jun. 29, 2022.

(51) Int. Cl. C08B 11/02

(52) U.S. Cl. CPC C08B 11/02

(57) ABSTRACT

The release of alkoxy ethers from a cellulose ether composition that contains alkoxy ethers can be reduced by contacting the cellulose ether composition with a zeolite having a silica to alumina molar ratio (SiO₂/Al₂O₃) greater than 3, in a quantity sufficient to adsorb at least some alkoxy ethers that are present.

### FIELD

This invention relates to the field of cellulose ethers.

### INTRODUCTION

It is known to produce cellulose ethers by reacting cellulose with various reagents. See, for example, U.S. Pat. No. 4,845,206 and Harika K et al., Basic Concepts of Cellulose Polymers—A Comprehensive Review. 3(3) Archives of Pharmacy Practice 202-216 (2012). In many cases, the reaction is a two-step process. In the first step, cellulose is contacted with aqueous alkali hydroxide to form an alkali cellulose. In the second step, the alkali cellulose is contacted with an etherifying agent that is suitable for the cellulose ether to be produced. For example, in production of methyl cellulose, the etherifying agent is methyl chloride. In the production of ethyl cellulose, the etherifying agent is ethyl chloride. In the production of hydroxypropyl cellulose, the etherifying agent is propylene oxide. Mixtures of etherifying agents can produce cellulose ethers with mixed ether substituents, such as ethyl methylcellulose or hydroxypropyl methylcellulose. After production, the cellulose ether is typically washed to remove impurities and dried. It may be ground to a powder, if not already in suitable powder form.

### SUMMARY

Side reactions during the production of cellulose ether may produce trace amounts of alkoxy ethers, such as 2-methoxyethanol (2-ME). For example, side reactions between the alkali hydroxide and the etherifying agent can produce alkanols. Other side reactions can produce glycols. Reaction between the alkanol and the glycol can produce the alkoxy ethers. Unlike other side-products, normal procedures to remove impurities from cellulose ethers may leave quantities of alkoxy ethers in the product. Later, the alkoxy ethers can slowly be released from the cellulose ether, causing undesirable odors.

We have discovered that properly selected zeolites can adsorb the alkoxy ethers and prevent their release to the atmosphere.

One aspect of the present invention is a method to reduce the release of alkoxy ethers from a cellulose ether composition, comprising the step of contacting the cellulose ether composition with zeolite having a silica to alumina molar ratio (SiO₂/Al₂O₃) greater than 3, in a quantity sufficient to adsorb at least some alkoxy ethers that are present.

A second aspect of the present invention is a cellulose ether composition that contains from 0.5 weight percent to 5 weight percent of zeolite having a silica to alumina molar ratio (SiO₂/Al₂O₃) greater than 3, wherein the weight percentages are based on the dry weight of the cellulose ether powder.

The process of the present invention can substantially reduce the off-gassing of alkoxy ethers from the cellulose ether.

### DETAILED DESCRIPTION

This invention begins with a cellulose ether composition that contains a small amount of alkoxy ether. The cellulose ether composition comprises cellulose ether, alkoxy ether and optionally other components.

The cellulose ether comprises cellulose macromolecules in which some hydroxyl groups have been substituted with alkoxy or substituted alkoxy groups. Some embodiments of the alkoxy or substituted alkoxy groups contain on average no more than 6 carbon atoms or no more than 4 carbon atoms or no more than 2 carbon atoms. In some embodiments, a substituted alkoxy group comprises a hydroxy or a carboxylic acid group.

Examples of suitable cellulose ethers include:
Alkyl cellulose ethers, such as methyl cellulose, ethyl cellulose and ethyl methyl cellulose;
Hydroxy-alkyl cellulose ethers, such as hydroxyethyl cellulose, hydroxypropyl cellulose and hydroxypropyl methylcellulose;
Carboxyalkyl cellulose ethers, such as carboxymethyl cellulose; and
Cellulose ethers that comprise a mixture of different substitutions, such as hydroxypropyl methylcellulose.

In some embodiments, the cellulose ether is an alkyl cellulose ether. In some embodiments, the cellulose ether is methyl cellulose or is ethyl cellulose or is ethyl methyl cellulose. In some embodiments, the cellulose ether is a hydroxy-alkyl cellulose ethers. In some embodiments, the cellulose ether is hydroxypropyl cellulose. In some embodiments, the cellulose ether is hydroxypropyl methylcellulose.

In some embodiments, the cellulose ether has a number average molecular weight of at least 5000 Da or at least 7500 Da or at least 10,000 Da. In some embodiments, the cellulose ether has a number average molecular weight of at most 2,000,000 Da or at most 1,200,000 Da or at most 1,000,000 Da. For lower viscosity cellulose ethers, it may be desirable to have number-average molecular weight no higher than 110,000 Da or 86,000 Da or 70,000 Da. For higher viscosity cellulose ethers, it may be desirable to have molecular weight at least 110,000 Da or at least 120,000 Da or at least 140,000 Da.

In some embodiments, a 1 percent aqueous solution of the cellulose ether, when measured as described in the test methods, has a viscosity of at least 10 cP or at least 100 cP or at least 1000 cP or at least 3000 cP or at least 5000 cP. In some embodiments, a 1 percent aqueous solution of the cellulose ether, when measured as described in the test methods, has a viscosity of at most 250,000 cP or at most 150,000 cP or at most 120,000 cP or at most 80,000 cP or at most 50,000 cP.

In some embodiments at least 10 percent of hydroxy groups in the cellulose are replaced with an alkoxy or substituted-alkoxy group, or at least 15 percent or at least 20 percent or at least 25 percent. In some embodiments at most 60 percent of hydroxy groups in the cellulose are replaced with an alkoxy or substituted-alkoxy group, or at most 50 percent or at most 40 percent or at most 36 percent.

In some embodiments, the cellulose ether is the product of a process comprising the steps of:
1. Contacting cellulose with an aqueous alkali hydroxide solution to form an alkali cellulose; and
2. Contacting the alkali cellulose with an etherifying compound to form a cellulose ether.

In some embodiments, the process further comprises one or more of the following steps:
3. Washing the cellulose ether to remove salt;
4. Drying the cellulose ether; and
5. Grinding the cellulose ether.

### Examples of these Steps are Illustrated in U.S. Pat. Nos. 4,845,206 and 6,261,218

In step (1), an example of the alkali hydroxide is sodium hydroxide. In some embodiments, the aqueous solution contains from 30 to 70 weight percent alkali metal hydroxide. In some embodiments, the temperature of step (1) is at least 10° C. or at least 20° C. or at least 30° C., and in some embodiments the temperature of step (1) is at most 70° C. or at most 60° C. In some embodiments, contact is maintained for at least 5 minutes and/or at most 90 minutes. In some embodiments, the reaction is carried out under an inert atmosphere such as nitrogen. In some embodiments, the reaction mixture is agitated. In some embodiments, residual hydroxide in the alkali cellulose is neutralized with an acid such as hydrochloric acid or acetic acid.

In step (2), examples of etherifying compounds include one or more of the following: alkyl halides such as methyl chloride or ethyl chloride, and epoxides such as ethylene oxide and propylene oxide. In some embodiments, step (2) is carried out under elevated pressure, such as 100 to 300 psi. In some embodiments, step (2) is carried out under elevated temperatures such as at least 50° C. or at least 60° C. In some embodiments, step (2) is carried out for at least 0.5 hours and/or at most 16 hours.

Any solvent that can dissolve residual salt in the cellulose ether may be used in step (3). In some embodiments, the solvent is water.

In some embodiments, step (4) is carried out under elevated temperature, such as 40° C. to 80° C., and/or under airflow. In some embodiments, the water content of the cellulose ether is reduced to at most 5 weight percent or at most 3 weight percent. In some embodiments, the water content of the cellulose ether is reduced to at least 0.5 weight percent or at least 0.8 weight percent or at least 1 weight percent.

Step (5) may be carried out with known grinding equipment, such as ball mills and hammer mills. The grinding may be carried out in the presence of a grinding aid such as a surfactant.

The alkoxy ether comprises a first alkyl group (R¹) linked to both a hydroxyl group and an alkoxy or substituted alkoxy group, as illustrated in Formula 1.

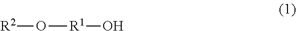

wherein R¹ is an alkyl group, and R² is an alkyl or substituted alkyl group. In some embodiments, R¹ and R² each independently contain at least 1 or at least 2 carbon atoms. In some embodiments, R¹ and R² each independently contain at most 6 or at most 4 or at most 3 carbon atoms. In some embodiments, R² further comprises a hydroxyl substituent. In some embodiments, R² is unsubstituted. Examples of potential alkoxy ethers include methoxymethanol, ethoxyethanol, ethoxymethanol and methoxyethanol, such as 2-methoxyethanol.

In many cases, the alkoxy ether is a residual side product from production of the cellulose ether. In some embodiments, the concentration of alkoxy ether in the cellulose ether is at least 100 μg/g or at least 250 μg/g or at least 400 μg/g, based on the dry weight of the cellulose ether. In some embodiments, the concentration of alkoxy ether is at most 800 μg/g or at most 600 g/g or at most 500 μg/g, based on the dry weight of the cellulose ether.

The cellulose ether composition may optionally contain other components. Examples of other components include residual salts, such as sodium chloride, and grinding aids. In many embodiments, the other components make up from 0 to 5 weight percent of the cellulose ether composition, or from 0 to 2 weight percent or from 0 to 1 weight percent, based on the dry weight of the cellulose ether. In many embodiments, the cellulose ether makes up at least 95 weight percent of the cellulose ether composition, excluding solvent, or at least 98 weight percent or at least 99 weight percent.

In some embodiments, the cellulose ether composition is substantially dry, comprising 0 to 5 weight percent solvent or 0 to 4 weight percent or 0 to 3 weight percent. In the process of this invention, the cellulose ether composition is contacted with a zeolite to adsorb alkoxy ethers in the cellulose ether composition.

Zeolites may be classified by the ratio of silicon to aluminum in the zeolite. This ratio is often calculated and reported as a molar ratio of the two oxides of silicon and aluminum:silica (SiO2) to alumina (Al₂O₃) (“silica to alumina molar ratio” or “SiO₂/Al₂O₃ molar ratio”). Zeolites used in this invention have a silica to alumina (SiO₂/Al₂O₃) molar ratio that is greater than 3. In some embodiments, the silica to alumina molar ratio is at least 3.5 or at least 4 or at least 4.5 or at least 5. In some embodiments, the silica to alumina molar ratio is no more than 1000 or no more than 900 or no more than 8000 or no more than 700.

In some embodiments, the zeolites have an average pore size of at least 2 Å or at least 3 Å or at least 4 Å or at least 5 Å. In some embodiments, the zeolites have an average pore size of at most 12 Å or at most 10 Å or at most 8 Å or at most 7.5 Å.

In some embodiments, the zeolites have an average pore volume of at least 0.1 cm³/g or at least 0.15 cm³/g or at least 0.17 cm³/g. In some embodiments, the zeolites have an average pore volume of at most 0.6 cm³/g or at most 0.55 cm³/g or at most 0.5 cm³/g.

In some embodiments, the zeolites have a surface area of at least 250 m²/g or at least 350 m²/g or at least 450 m²/g. In some embodiments, the zeolites have a surface area of at no more than 1000 m²/g or no more than 900 m²/g.

In some embodiments, the zeolites have an average grain size of at least 1 μm or at least 1.5 μm or at least 2 μm or at least 2.5 m. In some embodiments, the zeolites have an average grain size of no more than 150 μm or no more than 125 μm or no more than 100 μm or no more than 50 μm or no more than 30 μm or no more than 25 μm or no more than 20 μm.

In some embodiments, the zeolite may be selected from the group consisting of MFI zeolites and Y zeolites. In some embodiments, the zeolite is an MFI zeolite. In some embodiments, the zeolite is a Y zeolite. In some embodiments, the MFI zeolite is a ZSM type zeolite, and in some embodiments it is a ZSM-Na or ZSM-NH₃ zeolite. In some embodiments, the Y zeolite is a faujasite zeolite.

In some embodiments, the zeolites are calcined before use in order to drive off adsorbed water, especially for hydrophobic zeolites. In order to calcine, the zeolites may be maintained a temperature of at least 200° C. or at least 400° C. or at least 500° C. The best calcining period depends on the temperature, but for temperatures of at least 500° C., examples of the calcining period of at least 1 hour or at least 2 hours or at least 3 hours. There is no maximum temperature for calcining as long as the zeolites remain chemically stable, but temperatures above 700° C. are seldom necessary. There is no maximum time for calcining but for temperatures of at least 500° C., times over 10 hours are seldom necessary.

The quantity of zeolite should be sufficient to substantially adsorb the alkoxy ethers in the cellulose ether composition. In some embodiments, the quantity of zeolite is at least 0.1 weight percent of the dry weight of the cellulose ether, or at least 0.3 weight percent or at least 0.5 weight percent or at least 1 weight percent. In some embodiments, the quantity of the zeolite is at most 10 weight percent of the dry weight of the cellulose ether or at most 8 weight percent or at most 6 weight percent or at most 5 weight percent or at most 4 weight percent or at most 3 weight percent.

In some embodiments, the zeolite is present during the reactions to make the cellulose ether. For example, the zeolite may be blended with the cellulose or may be added with other reagents. In some embodiments, the zeolite is mixed with the cellulose ether as part of the purification process after the cellulose ether is made. In some embodiments, the zeolite is mixed with the dry cellulose ether after ordinary purification is complete. Regardless of when the zeolite is added, in some embodiments the zeolite is mixed substantially homogeneously throughout the cellulose ether.

In some embodiments, contact between the zeolites and the cellulose ether composition is maintained for at least 10 seconds or at least 20 seconds or 30 seconds or at least 1 minute or at least 5 minutes or at least 10 minutes or at least 30 minutes or at least 1 hour. In some embodiments, the zeolite and cellulose ether are agitated or tumbled during contact to ensure good mixing and good contact of the zeolite with all parts of the cellulose ether.

Optionally, the zeolite may be extracted from the cellulose ether after it has adsorbed the alkoxy ether. Alternatively, the zeolite may be left in place in the cellulose ether. Adsorbed alkoxy ethers desorb only slowly or not at all at ordinary temperatures for storage and use of cellulose ethers, so little measurable off-gassing of alkoxy ethers takes place.

After treatment with zeolites, in some embodiments the cellulose ether composition contains no more than 120 μg/g of the free alkoxy ether (alkoxy ether that is not adsorbed on the zeolite) or no more than 100 μg/g or no more than 80 μg/g or no more than 60 μg/g. There is no minimum desirable amount of free alkoxy ether, but in some cases, it may be impractical to reduce free alkoxy ether levels below 10 μg/g.

In some embodiments, the method of this invention reduces the concentration of free alkoxy ether in the cellulose ether composition to no more than 50 weight percent of pre-treatment concentrations or no more than 40 weight percent or no more than 30 weight percent or no more than 20 weight percent or no more than 15 weight percent or no more than 10 weight percent. There is no minimum desirable amount of free alkoxy ether, but in some cases, at least 1 weight percent of free alkoxy ether may remain.

Some embodiments of the invention are further illustrated in the following examples, but the examples do not limit the broad scope of the invention.

### Examples

### Test Methods

The following Test Methods are used the measure quantities described in this Application.

| | |
|---|---|
| Viscosity of | 1% solution in water, Haake Rotovisko RV 100, shear rate 2.55/s, 20° C. |
| Cellulose Ethers | |
| Si0₂/Al₂O₃ Molar | The Si/Al molar ratio is analyzed using wavelength dispersive x-ray |
| Ratio | fluorescence under helium using semi-quantitative omnium analysis |
| | to calculate the element composition. |
| Zeolite Pore Size | The zeolite is identified by X-ray powder diffraction patterns (XRD) |
| | using a Bruker D4 diffractometer operated at 40 KV and 40 mA with |
| | divergence slits set at 0.20 mm and antiscattering slit set at 0.25 mm. |
| | The crystal structure of the zeolites is by comparing the diffraction |
| | pattern to a public x-ray zeolite database (IZA Zeolite Structure |
| | Database). Pore size of each crystal structure is known. |
| Zeolite Pore Volume/ | The surface areas and pore volumes are measured by nitrogen |
| Zeolite Surface Area | adsorption at 77.4 K using the conventional technique on a |
| | Micromeritics ASAP 2420 apparatus. Prior to the adsorption |
| | measurements, the samples are degassed in vacuum at 300° C. for at |
| | least 3 hours. The pore volume is determined from the adsorption |
| | and desorption branch of isotherms using the Barret-Joyner-Halenda |
| | (BJH) procedure. The surface area is calculated using |
| | Brunauer-Emmett-Teller (BET) method |
| Zeolite Grain Size | The grain size of the zeolites is measure using microscopy on a |
| | scanning electron microscope (SEM) and measuring the size |
| | distribution of the grains present. |
| Alkoxy Ether | To test 2-methoxyethanol (2-ME) content of cellulose ethers, a 1.0 g |
| Content in Cellulose | sample of cellulose ether is weighed into a 20 mL headspace vial and |
| Ether | crimped. The vial and contents are heated to 75° C. for 15 minutes to |
| | drive off the 2-ME and the total 2-methoxyethanol is determined by |
| | gas chromatography. |

### Zeolites

The zeolites listed in Table 1 are calcined by heating in a 600° C. oven for four hours and then cooling to room temperature and storing in a sealed container until use.

TABLE 1

| | | | | | | Grain | Surface |
|---|---|---|---|---|---|---|---|
| | | | SiO₂/ | Pore | Pore Vol. | Size | Area |
| Zeolite | Type | Supplier | Al₂O₃ | Size (Å) | (cm3/g) | (μm) | (m²/g) |
| Abscents 3000 | MFI | Honeywell UoP | 650 | | 0.18 | 0.25-2 | 344 |
| CBV5524G | MFI (H-ZSM-5) | Zeolyst | 50 | 5-6 | | | |
| CBV 15014G | MFI (NH3-ZSM-5) | Zeolyst | 150 | 5-6 | 0.23 | 0.3-0.1 | 445 |
| CBV 400 | Y (FAU) | Zeolyst | 5 | 7 | 0.36 | 0.15-1 | 801 |
| CBV 901 | Y (FAU) | Zeolyst | 80 | 7 | 0.48 | 0.15-1 | 792 |
| Zeolite 4A | Na - Type A | IQE Group | 2 | 4 | 2 | | |
| Siolite 3AH | K - Type A | IQE Group | 2 | 3 | | | |
| Siolite 5AH | Ca - Type A | IQE Group | 2 | 5 | | | |
| Siolite 13X | X | IQE Group | 2.6-3 | 9 | | | |
| Natural Zeolite | Alumino silicate 6 | | | | | | |
| Zeoflair 810 | | Zeochem | | | | 7 | |

A commercial cellulose ether product contains about 80 percent hydroxy ethyl methyl cellulose and 20 percent starch ether modifier. A series of samples are made by mixing 1 g of the cellulose ether with each zeolite listed in Table 1, in an amount shown in Table 2, in a 20 mL headspace vial. The vial is capped and mixed on a vortex mixer for 30 seconds. The unadsorbed 2-ME content of each sample is measured as described in the Test Methods.

TABLE 2

| | | | | 2-ME |
|---|---|---|---|---|
| Example | | Wt % | 2-ME | Reduction |
| Number | Zeolite | Zeolite | (μg/g) | (%) |
| Control A | None | 0 | 165 | 0 |
| IE 1 | Abscents 3000 | 1.0 | 102 | 38 |
| IE 2 | Abscents 3000 | 2.0 | 65 | 61 |
| IE 3 | Abscents 3000 | 2.5 | 59 | 64 |
| IE 4 | Abscents 3000 | 4.0 | 34 | 79 |
| IE 5 | CBV400 | 2.5 | 74 | 55 |
| IE 6 | CBV901 | 2.5 | 100 | 39 |
| IE 7 | CBV 15014G | 2.5 | 62 | 63 |
| IE 8 (1) | CBV5524G | 2 | 4 | 93 |
| IE 9 (1) | CBV5524G | 2 | 4 | 93 |
| IE 10 (2) | CBV5524G | 2 | 25 | 92 |
| IE 11 | Abscents 3000 | 7.0 | 23 | 86 |
| IE 12 | Abscents 3000 | 10 | 19 | 88 |
| | Comparative | | | |
| | Examples | | | |
| CE 1 | Abscents 3000 | 0.5 | 134 | 19 |
| Control B | None | 0 | 445 | 0 |
| CE 2 | Siolite 3AH | 2 | 447 | <5 |
| CE 3 | Siolite 5AH | 2 | 435 | <5 |
| CE 4 | Zeolite 4A | 2 | 460 | <5 |
| CE 5 | Siolite 13X | 2 | 395 | 11 |
| CE 6 | Natural Z | 2 | 390 | 11 |
| CE 7 | Zeoflair 810 | 2 | 387 | 11 |

(1) A different base cellulose ether sample is used. The recovery for the control sample is 55.
(2) A different base cellulose ether sample is used. The recovery for the control sample is 310.

1. A method to reduce the release of alkoxy ethers from a cellulose ether composition that contains alkoxy ethers, comprising the step of contacting the cellulose ether composition with a zeolite having a silica to alumina molar ratio (SiO₂/Al₂O₃) greater than 3, in a quantity sufficient to adsorb at least some alkoxy ethers that are present.

2. The method of claim 1 wherein the weight ratio of zeolite to dry-weight of cellulose ether is more than 0.5% and no more than 10%.

3. The method of any one of claim 2 wherein the weight ratio of zeolite to dry-weight of cellulose ether is from 1% to 5%.

4. The method of claim 3 wherein the zeolite has a silica to alumina molar ratio (SiO₂/Al₂O₃) greater than 4.

5. The method of claim 3 wherein the zeolite has a silica to alumina molar ratio (SiO₂/Al₂O₃) greater than 5.

6. The method of claim 3 wherein the zeolite has an average pore size from 3 Å to 12 Å.

7. The method of claim 3 wherein the zeolite has an average pore size from 4 Å to 10 Å.

8. The method of claim 3 wherein the zeolite has a pore volume from 0.1 cm³/g to 0.6 cm³/g.

9. The method of claim 3 wherein the zeolite contains a Y zeolite.

10. The method of claim 3 wherein the zeolite contains an MFI zeolite.

11. The method of claim 3 wherein the zeolite contains a ZSM-5 zeolite.

12. The method of claim 3 wherein the cellulose ether composition contains methylcellulose, ethyl cellulose, ethyl methyl cellulose, hydroxyethyl cellulose, hydroxypropyl cellulose or hydroxypropyl methylcellulose.

13. The method of claim 3 wherein the alkoxy ether is 2-methoxyethanol.

14. The method of claim 3 wherein the method of this invention reduces the concentration of free alkoxy ether in the cellulose ether composition to no more than 40 weight percent of pre-treatment concentrations.

15. A cellulose ether composition that contains from 0.5 weight percent to 5 weight percent of zeolite having a silica to alumina molar ratio (SiO₂/Al₂O₃) greater than 3, wherein the weight percentages are based on the dry weight of the cellulose ether powder.
